(19) United States
(12) Patent Application Publication
(10) Pub. No.: US 2010/0262262 A1
(43) Pub. Date: Oct. 14, 2010

(54) Contents Recording System, Contents Recording Control Method, and Recording Medium Having Contents Recording Control Program Recorded Thereon

(75) Inventor: Haruyuki SHIMIZU, Suita City (JP)

Correspondence Address: NOVAK DRUCE + QUIGG LLP, 300 NEW JERSEY AVENUE, NW, FIFTH FLOOR, WASHINGTON, DC, 20001, US

(73) Assignee: SANYO ELECTRIC CO., LTD., Osaka (JP)

(21) Appl. No.: 12/756,482

(22) Filed: Apr. 8, 2010

(30) Foreign Application Priority Data
Apr. 8, 2009 (JP) 2009-094106

(51) Int. Cl. G05B 11/01

(52) U.S. Cl. 700/3; 700/2

(57) ABSTRACT

In order to synchronize the timings at which a plurality of IC recorders start recording contents, a contents recording system including a plurality of IC recorders includes first and second preparation portions to allow all of the plurality of IC recorders to make transition to a standby state in which contents can be recorded immediately, a detection portion to detect a state of each of the plurality of IC recorders, and a start control portion to allow the plurality of IC recorders to record, on condition that all of the plurality of IC recorders make transition to the standby state.

This application is based on Japanese Patent Application No. 2009-094106 filed with Japan Patent Office on Apr. 8, 2009, the entire content of which is hereby incorporated by reference.

### BACKGROUND OF THE INVENTION

1. Field of the Invention

The present invention relates to a contents recording system including a plurality of contents recording apparatuses, a contents recording control method, and a recording medium having a contents recording control program recorded thereon, and more particularly to a contents recording system suitable for simultaneously recording a plurality of contents, a contents recording control method, and a recording medium having a contents recording control program recorded thereon.

2. Description of the Related Art

When sounds produced by instruments played by more than one people are recorded, one piece of music data may be edited by recording each sound of a plurality of instruments and thereafter coupling the recorded sounds together. In this case, recording is simultaneously started in contents recording apparatuses respectively corresponding to a plurality of instruments in order to facilitate a synchronization operation when plural pieces of sound data recorded in a plurality of contents recording apparatuses are coupled together.

The contents recording apparatuses record sounds in recording mediums such as hard disks and flash memories. However, the time required for such processing as searching for a region in which sound data is recorded varies among the contents recording apparatuses. Therefore, even if a plurality of contents recording apparatuses are each instructed simultaneously to start recording, the time required to actually start recording varies among them.

Meanwhile, a technique is known which allows switching between a standby mode in which processing can be executed immediately and a sleep mode in which power consumption is reduced although processing cannot be executed immediately.

### SUMMARY OF THE INVENTION

The present invention is made to solve the aforementioned problem. An object of the present invention is to provide a contents recording system capable of synchronizing the timing of starting recording contents among a plurality of contents recording apparatuses.

Another object of the present invention is to provide a contents recording control method and a recording medium having a contents recording control program recorded thereon, which are capable of synchronizing the timing of starting recording contents among a plurality of contents recording apparatuses.

In order to achieve the above-noted object, in accordance with an aspect of the present invention, a contents recording system including a plurality of contents recording apparatuses includes: a preparation portion to allow all of the plurality of contents recording apparatuses to make transition to a standby state in which contents can be recorded immediately; a detection portion to detect a state of each of the plurality of contents recording apparatuses; and a start control portion to allow the plurality of contents recording apparatuses to record contents, on condition that it is detected that all of the plurality of contents recording apparatuses make transition to the standby state.

In accordance with another aspect of the present invention, a contents recording control method allows a computer, which controls any one or more of a plurality of contents recording apparatuses, to execute: a preparation step of allowing all of the plurality of contents recording apparatuses to make transition to a standby state in which contents can be recorded immediately; a detection step of detecting a state of each of the plurality of contents recording apparatuses; and a start control step of allowing the plurality of contents recording apparatuses to record contents, on condition that it is detected that all of the plurality of contents recording apparatuses make transition to the standby state.

In accordance with a further aspect of the present invention, a contents recording control program recorded on a recording medium allows a computer, which controls any one or more of a plurality of contents recording apparatuses, to execute: a preparation step of allowing all of the plurality of contents recording apparatuses to make transition to a standby state in which contents can be recorded immediately; a detection step of detecting a state of each of the plurality of contents recording apparatuses; and a start control step of allowing the plurality of contents recording apparatuses to record contents, on condition that it is detected that all of the plurality of contents recording apparatuses make transition to the standby state.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 shows an exemplary overview of a contents recording system in the present embodiment.

FIG. 2 is a plan view of an IC recorder.

FIG. 3 is a block diagram showing an overview of a hardware configuration of the IC recorder.

FIG. 4 is a functional block diagram showing an overview of functions of CPU of the IC recorder that functions as a master unit.

FIG. 5 is a functional block diagram of an overview of functions of CPU of the IC recorder that functions as a slave unit.

FIG. 6 is a first flowchart showing an exemplary flow of a recording process executed by CPU of the IC recorder.

FIG. 7 is a second flowchart showing an exemplary flow of a recording process executed by CPU of the IC recorder.

### DESCRIPTION OF THE PREFERRED EMBODIMENTS

In the following, an embodiment of the present invention will be described with reference to the figures. In the following description, the same parts are denoted with the same reference numerals. Their designations and functions are also the same. Therefore, a detailed description thereof will not be repeated.

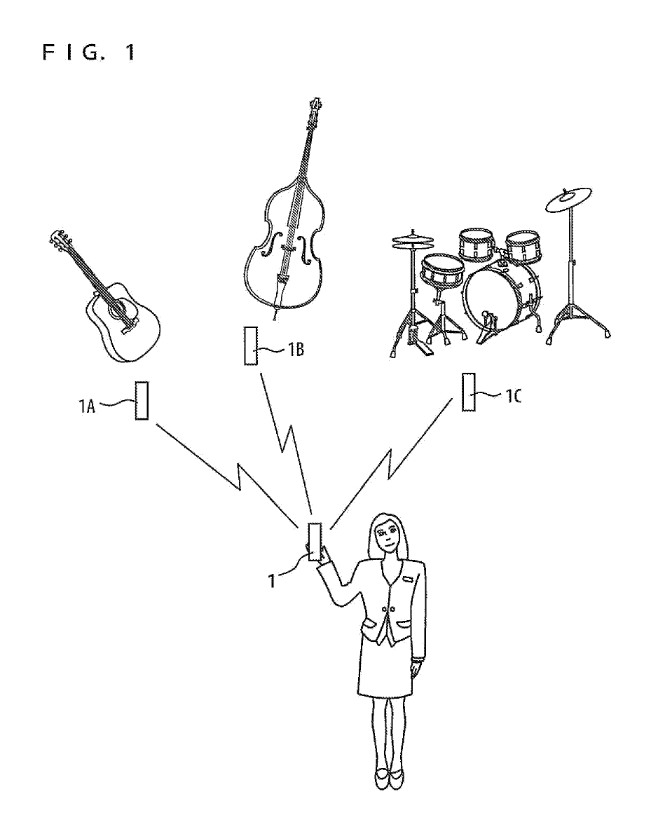

FIG. 1 shows an exemplary overview of a contents recording system in the present embodiment. Referring to FIG. 1, the contents recording system includes four IC recorders 1, 1A-1C serving as contents recording apparatuses. Here, IC recorders 1, 1A-1C are respectively owned by four people who constitute a group to perform music. The contents recording system is configurable when IC recorders 1, 1A-1C respectively owned by four people are present in a range in which they can communication with each other. Here, when four people perform music, one of whom is a vocalist, and other three of whom play a guitar, a bass guitar, and drums, respectively, the music is recorded by four IC recorders 1, 1A-1C. Specifically, vocal sounds are recorded by IC recorder 1 owned by the vocalist, guitar sounds are recorded by IC recorder 1A owned by the guitarist, bass guitar sounds are recorded by IC recorder 1B owned by the bassist, and drum sounds are recorded by IC recorder 1C owned by the drummer.

Audio data is recorded in each of IC recorders 1, 1A-1C. Four pieces of audio data can be edited, for example, synthesized into one by loading the four pieces of audio data into a computer or the like and allowing the computer to execute an application program for music editing. It is noted that four pieces of audio data need to be synchronized with each other when four pieces of audio data are synthesized into one. Here, if the starting times are synchronized such that the respective times at which four pieces of audio data start agree, synchronization can be achieved only by timing the respective starting times of four pieces of audio data to coincide with each other. Therefore, there is no need for adjusting the starting times. The contents recording system in the present embodiment enables agreement of the recording starting times among four IC recorders 1, 1A-1C.

Although it is shown by way of example that the contents recording system includes four IC recorders 1, 1A-1C, the number of IC recorders is not limited to four as long as more than one recorders are included. Furthermore, although IC recorders 1, 1A-1C are described as exemplary contents recording apparatuses, video cameras, digital still cameras, tape recorders, and the like may be employed as long as they have a recording function.

IC recorders 1, 1A-1C have the same hardware configuration and function, and therefore IC recorder 1 will be described unless otherwise specified.

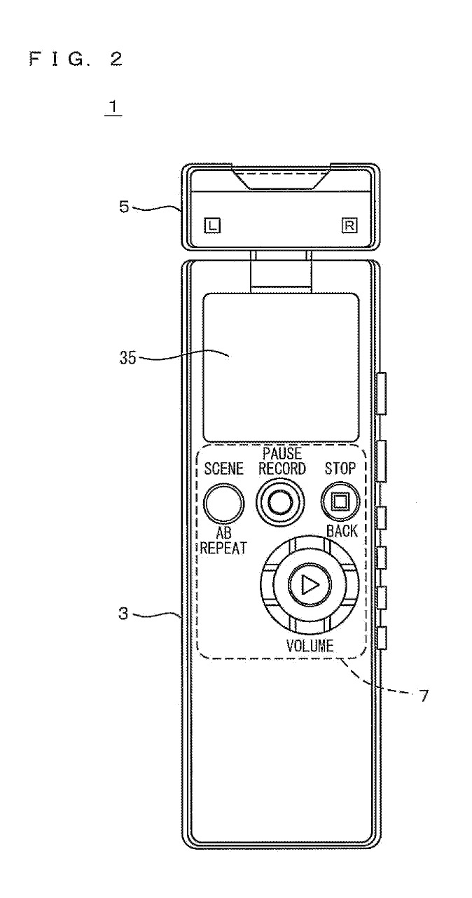

FIG. 2 is a plan view of the IC recorder. Referring to FIG. 2, IC recorder 1 includes a body portion 3 and a sound collecting portion 5 containing a directional microphone and a non-directional microphone.

Sound collecting portion 5 is connected to body portion 3 rotatably on two axes through a hinge mechanism so that the orientation of sound collecting portion 5 can be changed relative to body portion 3.

Body portion 3 includes a liquid crystal display (LCD) 35 and an operation portion 7 having different kinds of keys below. Operation portion 7 includes a hard key. The hard key is a contact switch. It is noted that a display such as an organic ELD (Electro Luminescence Display) may be used in place of LCD 35.

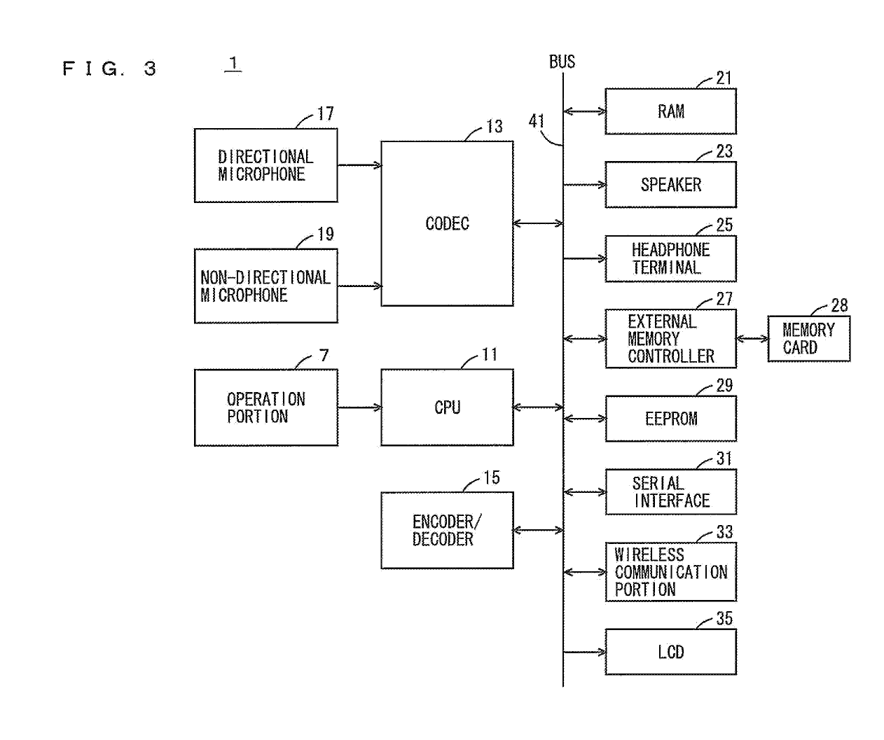

FIG. 3 is a block diagram showing an overview of a hardware configuration of the IC recorder. Referring to FIG. 3, IC recorder 1 includes a Central Processing Unit (CPU) 11 for controlling the entire IC recorder 1 as well as a codec 13, an encoder/decoder 15, a RAM (Random Access Memory) 21, a speaker 23, a headphone terminal 25, an external memory controller 27, an EEPROM (Electrically Erasable and Programmable Read Only Memory) 29, a serial interface (I/F) 31, a wireless communication portion 33, and LCD 35, each of which is connected to CPU 11 through a bus 41.

CPU 11 is connected to operation portion 7 to accept an operation input to operation portion 7 by the user. RAM 21 is used as a work area of CPU 11. EEPROM 29 stores, for example, a program executed by CPU 11. EEPROM 29 is an internal memory for storing a compressed audio signal and the like in a nonvolatile manner. A memory card 28 is connected to external memory controller 27. CPU 11 can access memory card 28 connected to external memory controller 27 through external memory controller 27.

Serial interface 31 is connected to a device capable of serial communication. CPU 11 can communicate with a device connected to serial interface 31 through serial interface 31. A headphone, earphones, etc. are connected to headphone terminal 25 so that an analog audio signal is output to them. Speaker 23 receives an analog audio signal to output sounds.

A directional microphone 17 and a non-directional microphone 19 are connected to codec 13 so that codec 13 converts an analog audio signal input from one of directional microphone 17 and non-directional microphone 19 into a digital signal in the PCM (Pulse Code Modulation) scheme for prescribed signal processing and thereafter outputs the digital processed audio signal to CPU 11.

Encoder/decoder 15 is controlled by CPU 11 to encode the audio signal output from codec 13. Furthermore, encoder/decoder 15 is controlled by CPU 11 to decode the encoded audio signal. The encoding method for encoding an audio signal by encoder/decoder 15 is, for example, MP3 (MPEG Audio Layer-3), though not limited thereto. When compressed audio data is to be stored, CPU 11 allows encoder/decoder 15 to encode the audio data and then stores the encoded audio data in EEPROM 29 or memory card 28 connected to external memory controller 27. On the other hand, when audio data is to be stored without being compressed, the audio signal output from codec 13 is stored as audio data, without being encoded by encoder/decoder 15, in EEPROM 29 or memory card 28 connected to external memory controller 27.

Furthermore, CPU 11 reads audio data stored in EEPROM 29 or memory card 28 connected to external memory controller 27, inputs the audio data decoded by encoder/decoder 15, if the audio data is compressed, or the audio data, if the audio data is not compressed, to codec 13, and allows codec 13 to convert the audio data into an analog signal. The analog audio signal is then output to speaker 23 or a headphone or earphones connected to headphone terminal 25.

Wireless communication portion 33 is controlled by CPU 11 to wirelessly communicate with other IC recorders 1A-1C in accordance with a communication standard (ZigBee) having a specification defined by IEEE 802.15.4. It is noted that the communication standard with which wireless communication portion 33 communicates is not limited to ZigBee and may be, for example, communication using electromagnetic waves, a wireless communication method using Bluetooth® or UWB (Ultra Wide Band), or infrared communication. Connection is not limited to wireless and may be wired.

CPU 11 loads a contents recording control program stored in EEPROM 29 or memory card 28 connected to external memory controller 27, into RAM 21 for execution. The recording medium having the contents recording control program recorded thereon is not limited to memory card 28 and may be an optical disk (CD-ROM (Compact Disc-Read Only Memory)/(MO (Magnetic Optical Disc/MD (Mini Disc)/DVD (Digital Versatile Disc)), an IC card (including a memory card), an optical card, a mask ROM, an EEPROM (Erasable Programmable ROM), or the like.

In the following description, IC recorder 1 owned by the vocalist serves as a master unit and other IC recorders 1A-1C serve as slave units, for the sake of brevity. IC recorders 1A-1C that function as slave units have the same functions, and therefore the functions of IC recorder 1A will be described here. The same functions as those shown in FIG. 2 and FIG. 3 are denoted with symbol “A” following the reference numerals shown in FIG. 2 and FIG. 3. For example, IC recorder 1A includes CPU 11A corresponding to CPU 11 of IC recorder 1.

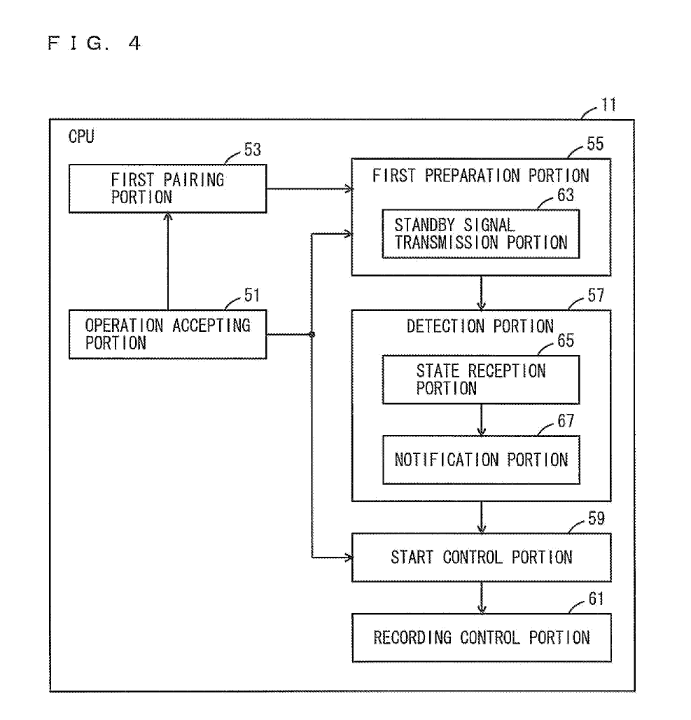

FIG. 4 is a functional block diagram showing an overview of the functions of CPU of the IC recorder that functions as a master unit. Referring to FIG. 4, CPU 11 of IC recorder 1 functioning as a master unit includes an operation accepting portion 51 accepting an operation by the user, a first pairing portion 53 for performing pairing with a slave unit, a first preparation portion 55 causing the paired slave unit to make transition to a standby state, a detection portion 57 detecting the state of the paired slave unit, a start control portion 59 for controlling the start of recording, and a recording control portion 61 controlling codec 13.

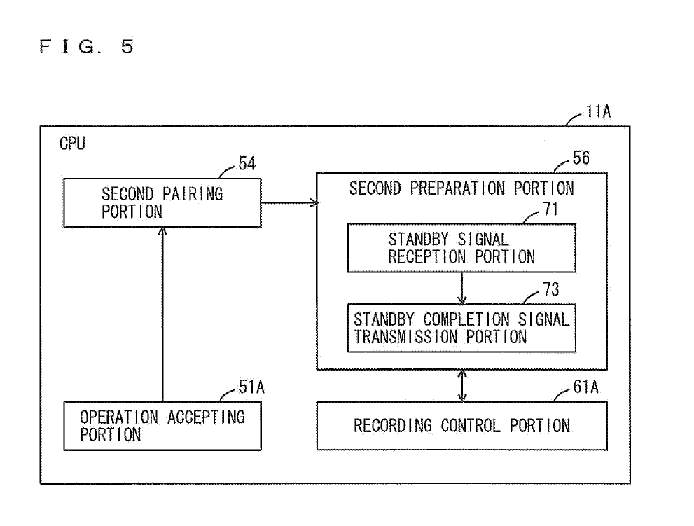

FIG. 5 is a functional block diagram showing an overview of functions of CPU of the IC recorder that functions as a slave unit. Referring to FIG. 5, CPU 11A of IC recorder 1A functioning as a slave unit includes an operation accepting portion 51A accepting an operation by the user, a second pairing portion 54 for performing pairing with a master unit, a second preparation portion 56 making a transition to a standby state, and a recording control portion 61A controlling codec 13.

Referring to FIG. 4 and FIG. 5, operation accepting portions 51, 51A accept operation input to operation portion 7 by the users. First pairing portion 53 and second pairing portion 54 accept a pairing instruction when the users designate the respective pairing instruction buttons provided beforehand in operation portions 7, 7A. When accepting a pairing instruction, first pairing portion 53 and second pairing portion 54 display a menu screen for selecting one of a master unit and a slave unit on LCD 35, 35A and accept an instruction to select one of a master unit and a slave unit as designated by the users on operation portions 7, 7A. Here, first pairing portion 53 accepts an instruction to select a master unit, and second pairing portion 54 accepts an instruction to select a slave unit.

First pairing portion 53 controls wireless communication portion 33 to transmit a pairing signal by broadcast and receive a pairing completion signal for a predetermined prescribed time. On the other hand, second pairing portion 54 controls wireless communication portion 33A and enters a standby state until it receives a pairing signal. Upon reception of a pairing signal, second pairing portion 54 obtains device identification information for identifying the master unit that has transmitted the pairing signal, here, IC recorder 1. The device identification information may be a predetermined address in a network with which wireless communication portion 33 communicates or may be a sign or number allocated beforehand to the device. Second pairing portion 54 stores the device identification information of IC recorder 1 as a master unit into RAM 21A thereby registering IC recorder 1 as a master unit. Second pairing portion 54 then controls wireless communication portion 33A to transmit a pairing completion signal to IC recorder 1.

First pairing portion 53 controls wireless communication portion 33 to obtain device identification information for identifying the slave unit that has transmitted the pairing completion signal, here, IC recorder 1A, if it receives a pairing completion signal before a prescribed time has elapsed after transmission of the pairing signal. First pairing portion 53 stores the device identification information of IC recorder 1A as a slave unit in RAM 21 thereby registering IC recorder 1A as a slave unit.

In each of IC recorders 1B, 1C, a pairing signal is received from IC recorder 1 as a master unit, and the device identification information of IC recorder 1 as a master unit is stored in RAM 21B, 21C so that IC recorder 1 is registered as a master unit. Furthermore, before a prescribed time has elapsed after transmission of the pairing signal, first pairing portion 53 receives a pairing completion signal from each of IC recorders 1B, 1C and registers their device identification information in RAM 21 thereby registering IC recorders 1B, 1C as slave units.

When a prescribed time has elapsed after transmission of the pairing signal, first pairing portion 53 outputs to first preparation portion 55 the respective device identification information of IC recorders 1A-1C as slave units that is stored in RAM 21.

When the user presses a standby button included in operation portion 7, operation accepting portion 51 accepts a standby instruction from operation portion 7. When accepting the standby instruction, operation accepting portion 51 outputs the standby instruction to first preparation portion 55. When accepting the standby instruction, first preparation portion 55 causes each of IC recorders 1A-1C as slave units to make transition to a standby state and in addition brings IC recorder 1 into a standby state in which recording is ready. In order to bring IC recorder 1 into a standby state, first preparation portion 55 executes a process for bringing memory card 28 into a state in which storage of audio data is ready. More specifically, first preparation portion 55 executes a process of searching memory card 28 for a free space and reserving a region in which audio data can be recorded.

First preparation portion 55 includes a standby signal transmission portion 63. Standby signal transmission portion 63 controls wireless communication portion 33 to transmit a standby signal including a command for causing transition to a standby state, to each of IC recorders 1A-1C, based on the device identification information of the slave units that is stored in RAM 21.

On other hand, second preparation portion 56 included in CPU 11A of IC recorder 1A as a slave unit includes a standby signal reception portion 71 and a standby completion signal transmission portion 73. Standby signal reception portion 71 controls wireless communication portion 33A to receive the standby signal from IC recorder 1 specified by the device identification information stored in RAM 21A. When receiving the standby signal, standby signal reception portion 71 brings IC recorder 1A into a standby state in which recording is ready, and upon transition to the standby state, outputs a standby completion signal to standby completion signal transmission portion 73.

When receiving the standby completion signal from standby signal reception portion 71, standby completion signal transmission portion 73 controls wireless communication portion 33A to transmit the standby completion signal to a master unit specified by the device identification information stored in RAM 21A, here, to IC recorder 1.

Detection portion 57 of IC recorder 1 as a master unit detects the respective states of IC recorder 1 itself and IC recorders 1A-1C specified by the device identification information of the slave units that is stored in RAM 21. Detection portion 57 outputs a completion signal to start control portion 59 when detecting that all of IC recorders 1A-1C enter the standby state.

Detection portion 57 includes a state reception portion 65 and a notification portion 67. State reception portion 65 controls wireless communication portion 33 to receive a standby completion signal from IC recorders 1A-1C specified by the device identification information of the slave units that is stored in RAM 21. It is determined that, among IC recorders 1A-1C specified by the device identification information of the slave units that is stored in RAM 21, the IC recorder that has transmitted the standby completion signal received by state reception portion 65 is in the standby state, and that the IC recorder of which standby completion signal has not been received by state reception portion 65 is not in the standby state.

When IC recorder 1 itself is in the standby state and the standby completion signal is received from all of IC recorders 1A-1C specified by the device identification information of the slave units that is stored in RAM 21, state reception portion 65 outputs a notification instruction to notification portion 67.

Notification portion 67 receives the notification instruction from state reception portion 65 and then displays a notification screen on LCD 35 to indicate that the master unit itself and all of the slave units enter the standby state. The notification screen includes, for example, all of the device identification information of the slave units stored in RAM 21 and a message “standby completed.” Accordingly, the user who operates IC recorder 1 as a master unit can know that all of IC recorders 1, 1A-1C are in the standby state in which recording is ready. It is noted that in place of or in addition to the notification screen displayed by notification portion 67, LED (Light Emitting Diode) provided beforehand in operation portion 7 may be caused to emit light.

When the user presses a record button included in operation portion 7, operation accepting portion 51 accepts a recording start instruction. When accepting the recording start instruction, operation accepting portion 51 outputs the recording start instruction to start control portion 59. When the recording start instruction is accepted, start control portion 59 outputs a recording instruction to recording control portion 61 on condition that a completion signal is input from detection portion 57, and in addition, start control portion 59 controls communication control portion 33 to transmit a recording start signal to all of IC recorders 1A-1C specified by the device identification information of the slave units that is stored in RAM 21.

Recording control portion 61 receives the recording instruction from start control portion 59 and then controls codec 13 and external memory controller 27 to allow codec 13 to convert an audio signal into a digital signal and allow memory card 28 to store the audio signal. Since external memory controller 27 is ready to immediately store audio data into memory card 28, audio data is stored upon input of a recording instruction. In the present embodiment, a description will be made to a case where audio data is stored without being compressed.

On the other hand, recording control portion 61A of IC recorder 1A as a slave unit controls wireless communication portion 33A to receive the recording start signal from IC recorder 1 as a master unit. When receiving the recording start signal, recording control portion 61A controls codec 13A and external memory controller 27 to allow codec 13A to convert an audio signal into a digital signal and allow memory card 28 to store the audio signal. Since external memory controller 27 is ready to immediately store audio data into memory card 28, audio data is stored upon reception of the recording start signal.

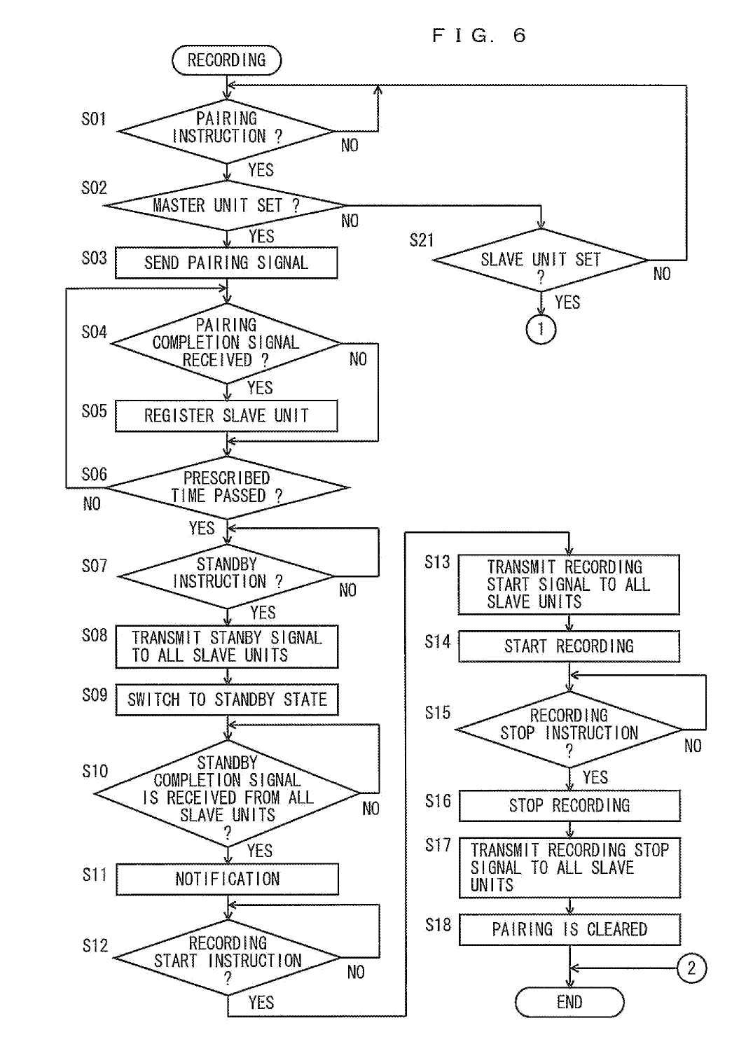

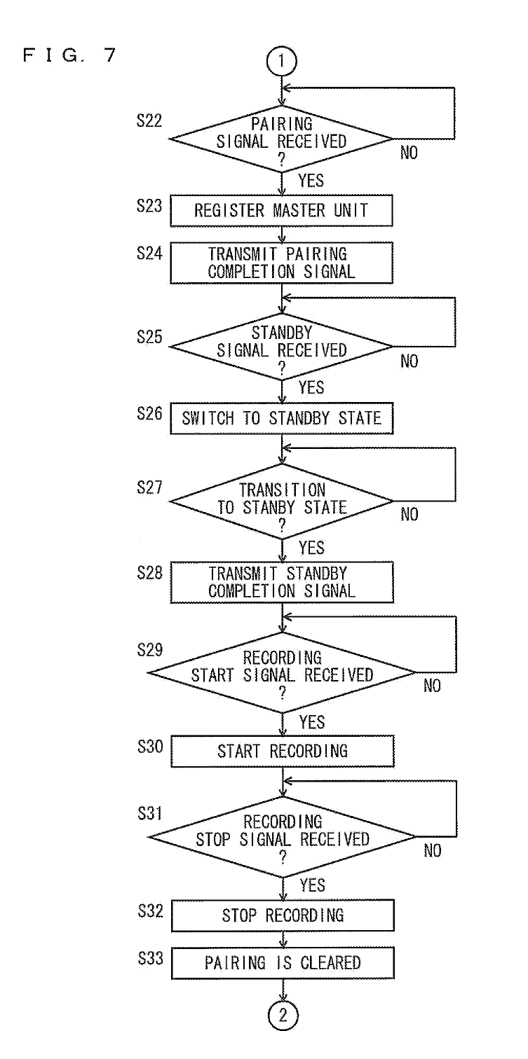

FIG. 6 and FIG. 7 are flowcharts showing an exemplary flow of a recording process. The recording process is a process executed by CPU when CPU of each of IC recorders 1, 1A-1C executes the contents recording control program. Here, each of the respective CPU 11, 11A of IC recorders 1, 1A executes the recording program, where IC recorder 1 is set as a master unit and IC recorder 1A is set as a slave unit, by way of example.

Referring to FIG. 6 and FIG. 7, CPU 11, 11A determine whether or not a pairing instruction is accepted (step S01). The process is waiting until a pairing signal is accepted (NO in step S01). When a pairing instruction is accepted (YES in step S01), the process proceeds to step S02. When the users designate the respective pairing instruction button provided beforehand in operation portions 7, 7A, a pairing instruction is accepted.

In step S02, it is determined whether a master unit is set or not. If a master unit is set, the process proceeds to step S03. If not, the process proceeds to step S21. In step S21, it is determined whether a slave unit is set or not. If a slave unit is set, the process proceeds to step S22. If not, the process returns to step S01. A menu screen for selecting one of a master unit and a slave unit is displayed on LCD 35, 35A, and when the users input an operation to designate one of them on operation portions 7, 7A, an instruction to select one of a master unit and a slave unit is accepted. Here, IC recorder 1 is set as a master unit, and therefore CPU 11 moves on to step S03 and executes processing in step S03 to step S17. On the other hand, IC recorder 1A is set as a slave unit, and therefore CPU 11A moves on to step S22 and executes processing in step S22 to step S33.

In step S03, CPU 11 controls wireless communication portion 33 to transmit a pairing signal. Then, it is determined whether wireless communication portion 33 receives a pairing completion signal or not (step S04). If a pairing completion signal is received, the process proceeds to step S05. If not, the process proceeds to step S06. In step S05, the IC recorder that has transmitted the pairing completion signal is registered as a slave unit (step S05), and the process then proceeds to step S06. Specifically, the device identification information of the one of IC recorders 1A, 1B, 1C that has transmitted the pairing completion signal is stored in RAM 21.

In step 5060, it is determined whether or not a prescribed time has elapsed. If a prescribed time has elapsed, the process proceeds to step S07. If not, the process returns to step S04. In other words, the IC recorder that has transmitted a pairing completion signal before a prescribed time has elapsed after transmission of the pairing signal in step S03 is registered as a slave unit.

On the other hand, CPU 11A of IC recorder 1A as a slave unit determines whether or not wireless communication portion 33 receives a pairing signal, in step S22. The process is waiting until a pairing signal is received (NO in step S22), and if a pairing signal is received, the process proceeds to step S23. Here, if a pairing signal is still not received after a prescribed time has elapsed, the process may be ended.

In step S23, the IC recorder that has transmitted the pairing signal is registered as a master unit. Specifically, the device identification information of the one of IC recorders 1, 1B, 1C that has transmitted the pairing signal, here, IC recorder 1, is stored in RAM 21A. In the next step S24, wireless communication portion 33A is controlled so that a pairing completion signal is transmitted to IC recorder 1 based on the device identification information stored in RAM 21A.

CPU 11 of IC recorder 1 as a master unit determines whether or not a standby instruction is accepted, in step S07. When the user presses a standby button included in operation portion 7, a standby instruction is accepted. The process is waiting until a standby instruction is accepted (NO in step S07), and if a standby instruction is accepted (YES in step S07), the process proceeds to step S08.

In step S08, a standby signal including a command for causing transition to a standby state is transmitted to each of all the IC recorders 1A-1C as slave units, based on the device identification information of the slave units that is stored in RAM 21. Then, the master unit is switched into a standby state (step S09). Specifically, a process for bringing about a ready state in which audio data can be stored immediately in memory card 28 is executed. More specifically, external memory controller 27 is controlled to execute a process for searching memory card 28 for a free space and reserving a region in which audio data can be recorded.

In the next step S10, wireless communication portion 33 is controlled to determine whether or not a standby completion signal is received from all of IC recorders 1A-1C specified by the device identification information of the slave units that is stored in RAM 21. The process is waiting until a standby completion signal is received from all of IC recorders 1A-1C (NO in step S10), and when a standby completion signal is received from all of IC recorders 1A-1C (YES in step S10), the process proceeds to step S11.

In step S11, the user is notified that all of the slave units are in the standby state. Specifically, a notification screen is displayed on LCD 35. The notification screen includes, for example, all of the device identification information of the slave units that is stored in RAM 21, and a message “standby completed.” Accordingly, the user who operates IC recorder 1 as a master unit can know that all of IC recorders 1, 1A-1C are in the standby state in which recording is ready.

On the other hand, CPU 11A of IC recorder 1A as a slave unit is waiting until a standby signal is received from IC recorder 1 as a master unit (NO in step S25), and when a standby signal is received (YES in step S25), the process proceeds to step S26. In step S26, IC recorder 1A is switched into a standby state. Specifically, a process for bringing about a ready state in which audio data can be stored immediately in memory card 28 is executed. More specifically, external memory controller 27 is controlled to execute a process of searching memory card 28 for a free space and reserving a region in which audio data can be recorded.

In step S27, it is determined whether or not transition to a standby state is made. The process is waiting until transition to the standby state is made (NO in step S27), and when transition to the standby state is made (YES in step S27), the process proceeds to step S28.

In step S28, wireless communication portion 33A is controlled so that a standby completion signal is transmitted to IC recorder 1 as a master unit. IC recorder 1 as a master unit is specified based on the device identification information stored in RAM 21A.

CPU 11 of IC recorder 1 as a master unit determines whether or not a recording start instruction is accepted, in step S12. When the user presses a record button included in operation portion 7, a recording start instruction is accepted. The process is waiting until a recording start instruction is accepted (NO in step S12). If a recording start instruction is accepted (YES in step S12), the process proceeds to step S13.

In step S13, wireless communication portion 33 is controlled so that a recording start signal is transmitted to each of all of IC recorders 1A-1C as slave units, based on the device identification information of the slave units that is stored in RAM 21. Recording is started in each of all of IC recorders 1A-1C as slave units, as described later.

In the next step S14, recording is started. Specifically, codec 13 and external memory controller 27 are controlled so that codec portion 13 converts an audio signal into a digital signal and audio data obtained by converting the audio signal into a digital signal is stored in memory card 28. Since external memory controller 27 is ready to immediately store audio data into memory card 28 in step S08, audio data is stored upon input of the recording instruction.

In step S15, it is determined whether or not a recording stop instruction is accepted. When the user presses a stop button included in operation portion 7, a recording stop instruction is accepted. The process is waiting until a recording stop instruction is accepted (NO in step S15). If a recording stop instruction is accepted (YES in step S15), the process proceeds to step S16.

In step S16, recording is stopped, and the process then proceeds to step S17. In step S17, wireless communication portion 33 is controlled so that a recording stop signal is transmitted to each of all of IC recorders 1A-1C as slave units, based on the device identification information of the slave units that is stored in RAM 21. Then, the pairing is cleared (step S18), and the process ends. The pairing is cleared by deleting the device identification information of the slave unit that is stored in RAM 21.

On the other hand, CPU 11A of IC recorder 1A as a slave unit determines whether or not wireless communication portion 33A receives a recording start signal from IC recorder 1 as a master unit, in step S29. The process is waiting until a recording start signal is received from IC recorder 1 as a master unit (NO in step S29), and when a recording start signal is received (YES in step S29), the process proceeds to step S30.

In step S30, recording is started. Specifically, codec 13A and external memory controller 27 are controlled so that codec portion 13A converts an audio signal into a digital signal and audio data obtained by converting the audio signal into a digital signal is stored in memory card 28. Since external memory controller 27 is ready to immediately store audio data into memory card 28 in step S25, audio data is stored upon reception of the recording start signal.

In step S31, it is determined whether or not wireless communication portion 33A receives a recording stop signal from IC recorder 1 as a master unit. The process is waiting until a recording stop signal is received (NO in step S31), and when a recording stop signal is received (YES in step S31), the process proceeds to step S32.

In step S32, recording is stopped. Then, the pairing is cleared (step S33), and the process ends. The pairing is cleared by deleting the device identification information of the master unit that is stored in RAM 21A. As described above, the contents recording system in the present embodiment includes four IC recorders 1, 1A-1C. IC recorder 1 serving as a master unit switches the IC recorder 1 itself into a standby state and in addition, transmits a standby signal to all of IC recorders 1A-1C serving as slave units to cause all of IC recorders 1A-1C to make transition to a standby state. The states of IC recorders 1A-1C are detected, and recording is started in four IC recorders 1, 1A-1C on condition that it is detected that all of four IC recorders 1, 1A-1C make transition to a standby state. Therefore, the time for four IC recorders 1, 1A-1C to enter the standby state, which is different among them, can be timed to the last one, so that the respective timings at which IC recorders 1, 1A-1C start recording can be synchronized.

Furthermore, IC recorder 1 as a master unit transmits a standby signal for causing transition to a standby state to IC recorders 1A-1C as slave units and receives from each of IC recorders 1A-1C a standby completion signal indicating that transition to a standby state has been made. Therefore, it can be detected by IC recorder 1 as one master unit that all of IC recorders 1, 1A-1C enter the standby state.

In addition, in response to the detection that all of IC recorders 1, 1A-1C have made transition to the standby state, a notification screen is displayed on LCD 35 to give a notification that all of IC recorders 1, 1A-1C have made transition to the standby state, so that the user can be notified that recording is ready.

Moreover, IC recorders 1, 1A-1C start recording in response to IC recorder 1 accepting an operation for starting recording, so that the user can designate the timing of starting recording.

Although, in the foregoing embodiment, IC recorder 1 is set as a master unit in the contents recording system including IC recorders 1, 1A-1C, any one of IC recorders 1, 1A-1C may be set as a master unit. Although IC recorder 1 as a master unit performs recording in the foregoing description, IC recorder 1 as a master unit may not perform recording. A computer such as a remote controller for remotely operating IC recorders 1, 1A-1C may be set as a master unit.

Although sounds have been described here as an example of contents, the contents include moving images and a combination of moving images and sounds. Furthermore, although IC recorders 1, 1A-1C have been described as an example of the contents recording apparatus, for example, a digital camera which records moving images or a combination of moving images and sounds may be employed.

It is needless to say that the present invention can be understood as a contents recording control method for executing the process shown in FIG. 6 and a contents recording control program for allowing a computer controlling one or more of a plurality of contents recording apparatuses to execute the contents recording control method.

The program referred to herein includes not only a program directly executable by CPU 11 but also a source program, a compressed program, an encrypted program, and the like.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A contents recording system including a plurality of contents recording apparatuses comprising:
a preparation portion to allow all of said plurality of contents recording apparatuses to make transition to a standby state in which contents can be recorded immediately;
a detection portion to detect a state of each of said plurality of contents recording apparatuses; and
a start control portion to allow said plurality of contents recording apparatuses to record contents, on condition that it is detected that all of said plurality of contents recording apparatuses make transition to the standby state.

2. The contents recording system according to claim 1, wherein
said plurality of contents recording apparatuses include one master unit, and
said master unit includes said preparation portion, said detection portion, and said start control portion.

3. The contents recording system according to claim 2, wherein
said preparation portion includes a transmission portion to transmit, to at least one slave unit other than said master unit of said plurality of contents recording apparatuses, a standby signal for causing transition to a standby state in which contents can be recorded immediately, and
said detection portion includes a state reception portion to receive, from each of said at least one slave unit, a standby completion signal indicating that transition to the standby state is made.

4. The contents recording system according to claim 1, further comprising a notification portion to make a notification that all of said plurality of contents recording apparatuses make transition to the standby state, in response to said detection portion detecting that all of said plurality of contents recording apparatuses make transition to the standby state.

5. The contents recording system according to claim 1, wherein said start control portion includes an operation accepting portion to accept an operation for allowing said plurality of contents recording apparatuses to record contents.

6. A contents recording control method allowing a computer, which controls any one or more of a plurality of contents recording apparatuses, to execute:
a preparation step of allowing all of said plurality of contents recording apparatuses to make transition to a standby state in which contents can be recorded immediately;
a detection step of detecting a state of each of said plurality of contents recording apparatuses; and
a start control step of allowing said plurality of contents recording apparatuses to record contents, on condition that it is detected that all of said plurality of contents recording apparatuses make transition to the standby state.

7. The contents recording control method according to claim 6, wherein
said plurality of contents recording apparatuses include one master unit, and
said master unit is allowed to execute said detection step, said preparation step, and said start control step.

8. The contents recording control method according to claim 7, wherein
said preparation step includes a step of transmitting, to at least one slave unit other than said master unit of said plurality of contents recording apparatuses, a standby signal for causing transition to a standby state in which contents can be recorded immediately, and
said detection step includes a step of receiving, from each of said at least one slave unit, a standby completion signal indicating that transition to the standby state is made.

9. The contents recording control method according to claim 6, further comprising a step of making a notification that all of said plurality of contents recording apparatuses make transition to the standby state, in response to detecting that all of said plurality of contents recording apparatuses make transition to the standby state in said detection step.

10. The contents recording control method according to claim 6, wherein said start control step includes a step of accepting an operation for allowing said plurality of contents recording apparatuses to record contents.

11. A recording medium having a contents recording control program recorded thereon for allowing a computer, which controls any one or more of a plurality of contents recording apparatuses, to execute:
a preparation step of allowing all of said plurality of contents recording apparatuses to make transition to a standby state in which contents can be recorded immediately;
a detection step of detecting a state of each of said plurality of contents recording apparatuses; and
a start control step of allowing said plurality of contents recording apparatuses to record contents, on condition that it is detected that all of said plurality of contents recording apparatuses make transition to the standby state.

12. The recording medium having the contents recording control program recorded thereon according to claim 11, wherein
said plurality of contents recording apparatuses include one master unit, and
said master unit is allowed to execute said detection step, said preparation step, and said start control step.

13. The recording medium having the contents recording control program recorded thereon according to claim 12, wherein
said preparation step includes a step of transmitting, to at least one slave unit other than said master unit of said plurality of contents recording apparatuses, a standby signal for causing transition to a standby state in which contents can be recorded immediately, and
said detection step includes a step of receiving, from each of said at least one slave unit, a standby completion signal indicating that transition to the standby state is made.

14. The recording medium having the contents recording control program recorded thereon according to claim 11, further comprising a step of making a notification that all of said plurality of contents recording apparatuses make transition to the standby state, in response to detecting that all of said plurality of contents recording apparatuses make transition to the standby state in said detection step.

15. The recording medium having the contents recording control program recorded thereon according to claim 11, wherein said start control step includes a step of accepting an operation for allowing said plurality of contents recording apparatuses to record contents.
